(19) United States
(12) Patent Application Publication
(10) Pub. No.: US 2009/0076902 A1
(43) Pub. Date: Mar. 19, 2009

(54) ADVERTISING WITHIN ADDRESS BOOKS

(75) Inventors: George Grinsted, Stockholm (SE); Lee Parry, Stockholm (SE)

Correspondence Address: FIALA & WEAVER, P.L.L.C.;C/O INTELLEVATE, P.O. BOX 52050, MINNEAPOLIS, MN, 55402, US

(73) Assignee: YAHOO! INC., Sunnyvale, CA (US)

(21) Appl. No.: 11/856,584

(22) Filed: Sep. 17, 2007

(51) Int. Cl. G06Q 30/00

(52) U.S. Cl. 705/14

(57) ABSTRACT

Methods, systems, and apparatuses for advertising using address book tools are provided. A plurality of contact entries is stored in a contact database for a user. The user is enabled to interact with the stored contact entries, including a contact entry identified as a business contact entry. The business contact entry of the contact database and a selected advertisement are displayed when the user views the business contact entry.

### BACKGROUND OF THE INVENTION

1. Field of the Invention

The present invention relates to advertising and to electronic address/contact books.

2. Background Art

An electronic address book is an electronic database that stores entries called contacts, and enables a user of the electronic address book to access the contact entries. An electronic address book that operates on a computer is referred to as an address book tool. Each contact entry in an electronic address book includes contact information for an entity of interest to the user. Each contact entry may include one or more standard fields, such as first name, last name, company name, address, telephone number, e-mail address, fax number, mobile phone number, etc. Electronic address books enable users to quickly find contact information for desired contacts. Electronic address books typically store contact information in alphabetical order based on the names of the people/businesses corresponding to the contact entries.

According to one definition, advertising is a paid, one-way communication through a medium in which an advertiser is identified, and the message (i.e., the advertisement) provided by the advertiser is controlled. Advertising may be performed for a variety of purposes, including publicity, public relations, product placement, sponsorship, underwriting, and sales promotion. A variety of mediums are used to convey an advertisement, including television, radio, movies, magazines, newspapers, the Internet, and billboards.

Online Advertising relates to the promoting of products and services using the World Wide Web. Typical online advertisement types include banner ads, floating ads, pop-up ads, and video ads which are provided through a browser to the user's computer desktop. Online advertising tends to be untargeted. Typically, online advertisement strategy involves placing an advertisement on the computer desktop of as many computer users as possible, in the hopes that at least a few computer users will be interested. Such untargeted advertising tends to be inefficient, and may be annoying to many computer users whose computer desktop may seem cluttered with undesired and uninteresting advertisements.

Thus, what is desired are more efficient ways of providing advertisements to computer users. What is desired are ways of targeting advertisements of interest more specifically to computer users, without adding clutter to the computer desktops of the computer users, or otherwise inconveniencing the computers users, as frequently occurs in conventional online advertisement techniques.

### BRIEF SUMMARY OF THE INVENTION

Methods, systems, and apparatuses for advertising using an address book tool are provided. Advertisements relating to business contact entries in an address book tool are displayed when viewing the business contact entries using the address book tool. For instance, a business contact entry may be displayed with an advertisement for the business contact entry, or with an advertisement for a competitor of the business contact entry. Such advertising enables highly targeted advertising from businesses to users of address tool books, because the advertisements can be selected to correspond to businesses listed in the address book tools of the users.

In one example, a plurality of contact entries is stored in a contact database for a user. The user is enabled to interact with the stored contact entries, including being enabled to interact with a contact entry identified as a business contact entry. The business contact entry of the contact database and a selected advertisement are displayed when the user views the business contact entry.

Contact data may be entered into the contact database in any manner. For example, contact data may be manually entered into the contact database by the user, and/or may be received from a plurality of other contact data sources (e.g., by a contact entry collection mechanism).

Contact entries of the contact database may be ranked based one or more criteria. For instance, a contact entry may be ranked based on a source from which the contact entry is received, based on a number of sources from which the contact entry is received, a frequency of access of the contact entry by the user, and/or by further criteria.

Advertisements may be selected for display in any manner. For instance, an advertisement may be selected based on an attribute of the user, such as a location (e.g., a home location, a work location, etc.) of the user. A selected advertisement may be an advertisement of the business contact entry. Alternatively, the selected advertisement may be an advertisement of a competitor business to the business contact entry.

Advertisements may be displayed in any manner. For example, the business contact entry may be displayed in a contact card format having a boundary. The selected advertisement may be displayed within the boundary of the business contact entry. Alternatively, the selected advertisement may be displayed overlapping or adjacent to (but outside) the business contact entry. The business contact entry and the selected advertisement may be displayed singly, or in a list or array of contact entries of the contact database.

In an example, an address book system may include a contact database, an address book tool, and an advertisement selector. The contact database is configured to store contact entries for a user. The address book tool is configured to enable the user to interact with the stored contact entries. The advertisement selector is configured to select an advertisement corresponding to a business contact entry stored in the contact database. The address book tool is configured to enable a display device to display the business contact entry with the selected advertisement when the user interacts with the address book tool to view the business contact entry.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example address book system.

FIG. 2 shows a contact entry file that includes fields for a stored contact entry.

FIGS. 3 and 4 show views of an individual contact entry and a business contact entry, respectively.

FIG. 5 shows a display that displays a list of contact entries.

FIG. 6 shows a flowchart providing example steps for collecting contact entries.

FIG. 7 shows a contact collection system, according to an example embodiment of the present invention.

FIG. 8 shows a contact entry ranking module, according to an embodiment of the present invention.

FIG. 9 shows a flowchart providing example steps for displaying advertisements in an address book tool, according to an example embodiment of the present invention.

FIGS. 10 and 11 show block diagrams of address book systems, according to example embodiments of the present invention.

FIGS. 12-16 show example steps for selecting advertisements, according to embodiments of the present invention.

FIG. 17 shows first, second, and third contact databases, corresponding to first, second, and third individuals, according to an example embodiment of the present invention.

FIG. 18 shows a flowchart providing example steps for displaying a contact entry and a corresponding advertisement, according to an example embodiment of the present invention.

FIG. 19 shows a block diagram of a display displaying a business contact entry and a selected advertisement, according to an example embodiment of the present invention.

FIG. 20 shows a displayed business contact entry that incorporates an advertisement as replacement information, according to an example embodiment of the present invention.

FIG. 21 shows a step for displaying a contact entry and a corresponding advertisement, according to an example embodiment of the present invention.

FIGS. 22 and 23 show block diagrams of displays of lists of contact entries and associated advertisements, according to example embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Example Embodiments

The example embodiments described herein are provided for illustrative purposes, and are not limiting. Further structural and operational embodiments, including (modifications/alterations, will become apparent to persons skilled in the relevant art(s) from the teachings herein.

Embodiments of the present invention enable advertisements to be displayed using an address book tool. When a user views contact entries of the address book tool, one or more advertisements are displayed to the user. According to embodiments, the advertisements are provided to the user in a more targeted manner than in conventional advertisement techniques. For example, advertisements may be displayed that correspond to preferences/attributes of the user, such as the user's location. In another example, advertisements are provided that correspond too businesses of interest of the user, by selecting advertisements correspond to business contacts that are present in the address book tool. In one example, advertisements for the business contacts are selected to be displayed. In another example, advertisements for competitors of the business contacts are selected to be displayed. According to these and further examples described below, more effective techniques for advertising are provided.

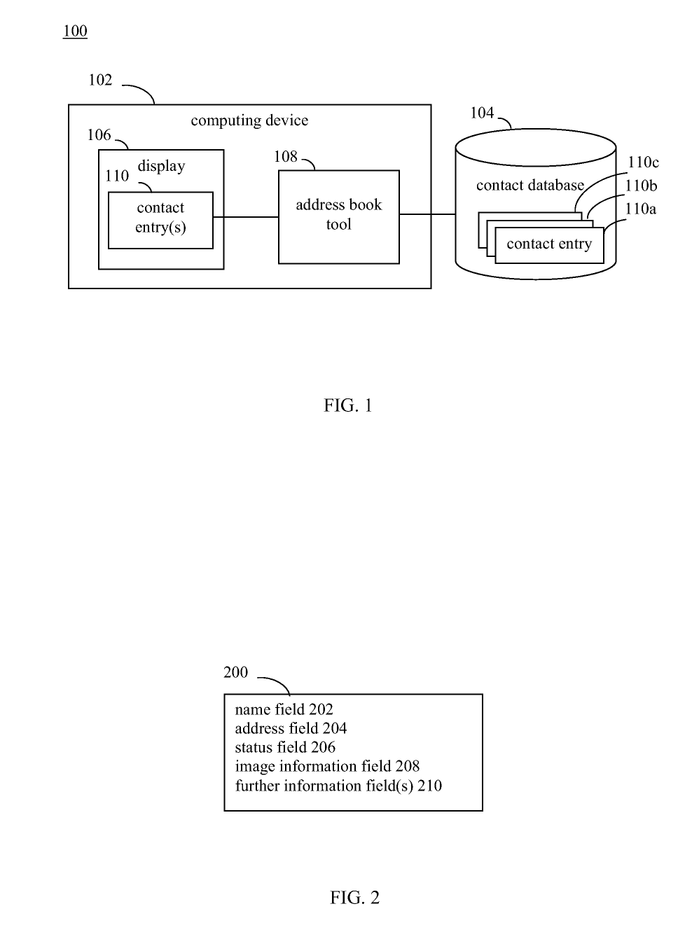

Address book tools are computer-based tools that enable the storing of contact entries, and that enable a user to interact with the stored contact entries. A variety of address book tools exist. FIG. 1 shows an example address book system 100. Address book system 100 is provided for illustrative purposes, but is not intended to be limiting. Embodiments of the present invention are adaptable to all types of address book systems.

As shown in FIG. 1, address book system 100 includes a computing device 102 and a contact database 104. Computing device 102 includes a display 106 and an address book tool 108. Computing device 102 may be any type of computing device, such as a desktop computer, a server, a mobile phone (e.g., a cell phone), a mobile computing device (e.g., a laptop computer, handheld computer, personal digital assistant (PDA), etc.), a handheld music player, a handheld email tool (e.g., a BLACKBERRY device, etc.), and further types of computing devices. Computing device 102 may be implemented in hardware, software, firmware, or any combination thereof. For example, in an embodiment, computing device 102 may include one or more processors that execute software.

Address book tool 108 may be any type of address book tool, including a proprietary or commercially available address book tool. Address book tool 108 may be a standalone tool, or may be packaged with other tools/functionality (e.g., may be packaged with common business applications, online social networking applications, etc.). Address book tool 108 enables contact information for contacts (e.g., individuals, businesses, etc.) to be stored, and makes the information accessible to a user of computing device 102. All types of contacts may be stored, including “close tie” contacts, such as a user's friends, colleagues, contacts for services such as the user's bank, favorite restaurants, taxi firms, local state-run services, home and work locations of the user, etc. Address book tool 108 may be a software program executing in one or more processors of computing device 102. Alternatively, although shown residing in computing device 102 in FIG. 1, address book tool 108 may reside (partially or entirely) on a computer system (e.g., a server) remote from computing device 102. In an example of such an implementation, address book tool 108 may be browser-accessible (e.g., Internet-based). Address book tool 108 may be implemented in hardware, software, firmware, or any combination thereof.

Display 106 may be any type of display device suitable for viewing images (e.g., text, graphics, etc.), such as a video monitor (e.g., CRT), a flat panel display such as an LCD (liquid crystal display), etc.

Contact database 104 may be any type of database that stores contact information for an address book tool. As shown in FIG. 1, contact database 104 stores a plurality of contact entries 110a-110c. Although three contact entries 110a-110c are shown in FIG. 1, contact database 104 may store any number of contact entries 110 for a user of computing device 102, including 10's and 100's of contact entries 110. Contact database 104 may reside externally to computing device 102 (as shown in FIG. 1), or may reside within computing device 102. For example, when residing externally, contact database 104 may be accessed by computing device 102 by coupling computing device 102 to a communication link (e.g., a USB connection, a FIREWIRE connection, etc.) or to a network, such as a local area network (LAN), a wide area network (WAN), or combination of networks such as the Internet. When residing internally to computing device 102, contact database 104 may reside in a storage device of computing device 102. Each contact entry 110 of contact database 104 may include one or more fields, such as first name, last name, company name, address, telephone number, e-mail address, fax number, mobile phone number, etc.

FIG. 2 shows an example contact entry file 200 that includes fields for a stored contact entry 110. Contact entry file 200 may represent a business contact entry or an individual (person) contact entry. Contact entry file 200 can have any format, including a proprietary or standard file format. For example, contact entry file 200 may be a vCard file. The vCard standard format is described in “vCard: The Electronic Business Card,” Version 2.1, a versit Consortium Specification, Sep. 18, 1996, which is incorporated by reference herein in its entirety. As shown in FIG. 2, contact entry file 200 includes a name field 202, an address field 204, a status field 206, an image information field 208, and one or more further information fields 210. Any combination of one or more of these fields and/or additional/alternative fields may be present.

When representing an individual contact entry, name field 202 may include a name of the individual, address field 204 may include an address of the individual, status field 206 may include a status of the individual, including an online status or a non-online related status (e.g., at work, at sleep, on vacation, etc.), and image information field 208 may include a filename for a picture, avatar, or other image representative of the individual. Any number of alternative and/or further information fields 210 may be present to include further information regarding the individual contact entry, such as a home phone number, a mobile phone number, information regarding the individual's profession, etc. Example values for fields 202-210 for an individual contact entry are shown as follows:

name field 202: Mr. George McGinley
address field 204: 3976 Maple Street, Concord, Massachusetts 01742
status field 206: on vacation
image information field 208: gmcginleyphoto.jpg
information field 210a: (351) 789-2345
information field 210b: Architect.gif

In the above example, information field 210a contains a home phone number for the individual, while information field 210b contains a filename of an image that identifies the profession of the individual.

When representing a business contact entry, name field 202 may include a name of the business, address field 204 may include an address of the business, status field 206 may include a status of the business (e.g., open, closed, etc.), and image information field 208 may include a filename for a picture, logo, or other image representative of the business. Any number of further information fields 210 may be present to include further information regarding the business contact entry, such as a business phone number, a facsimile phone number, a description of the business, etc. Example values for fields 202-210 for a business contact entry are shown as follows:

name field 202: Joe's Pizza
address field 204: 243 First Street, Sunnyvale, California 94090
status field 206: open noon-11:00pm everyday
image information field 208: joespizzalogo.jpg
information field 210a: (408) 889-1904
information field 210b: pizzaimage.com

In the above example, information field 210a contains a business phone number for the business, while information field 210b contains a filename of an image file that identifies the product of the business.

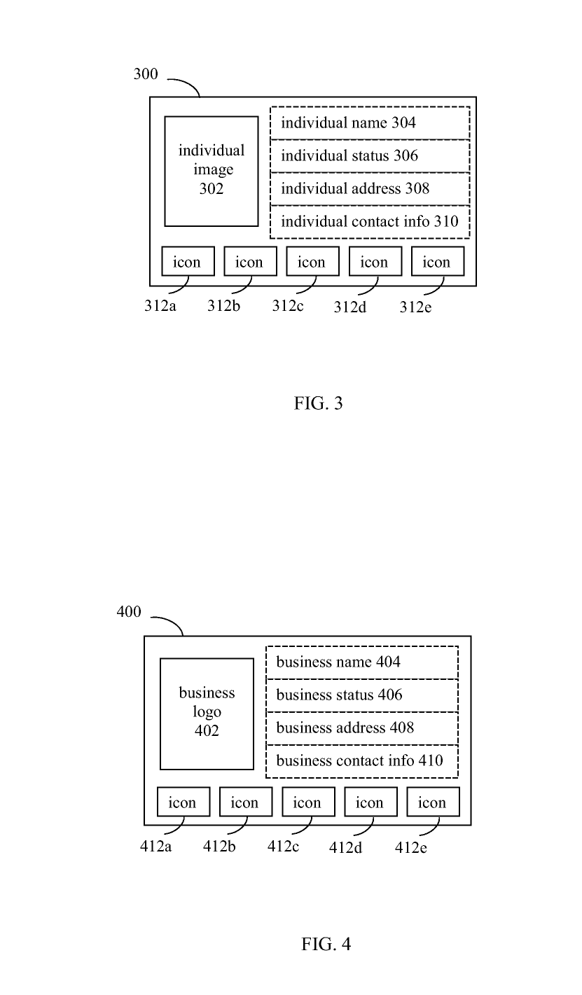

Address book tool 108 reads one or more files 200 corresponding to contact entries 110 from contact database 104 in response to a user interacting with computing device 102 to view one or more contacts. The fields of file 200 are used by address book tool 108 to generate a graphical display (e.g., text, images, etc.) for display by display 106 of the one or more contact entries 110. FIGS. 3 and 4 show example block diagram views of an individual contact entry 300 and a business contact entry 400, respectively, as may be displayed by display 106. Individual contact entry 300 and business contact entry 400 are example graphical depictions of contact entries 110 shown in FIG. 1.

As shown in the example of FIG. 3, individual contact entry 300 includes an individual image 302, an individual name 304, an individual status 306, an individual address 308, an individual contact information 310, and first-fifth icons 312a-312b. An image of the individual (e.g., from image information field 208 described above) is displayed at individual image 302. A name of the individual (e.g., from name field 202 described above) is displayed at individual name 304. A status of the individual (e.g., from status field 206 described above) is displayed at individual status 306. An address of the individual (e.g., from address field 204 described above) is displayed at individual address 308. Contact information of the individual (e.g., from further information field 210a described above) is displayed at individual contact information 310. Various graphical indications of information regarding the individual may be displayed at first-fifth icons 312a-312e. For example, one of icons 312a-312e may be an image that identifies a profession of the individual (e.g., an image file from further information field 210b shown above). Icons 312a-312e can be “vitality” icons indicating online status of the individual, such as a status of content uploaded by the individual (e.g., video, photographs such as Flickr™ uploads, etc.), profile comments, status changes, location changes, avatar changes, etc.

As shown in the example of FIG. 4, business contact entry 400 includes a business logo 402, a business name 404, a business status 406, a business address 408, a business contact information 410, and first-fifth icons 412a-412b. A logo of the business (e.g., from image information field 208 described above) is displayed at business image 402. A name of the business (e.g., from name field 202 described above) is displayed at business name 404. A status of the business (e.g., from status field 206 described above) is displayed at business status 406. An address of the business (e.g., from address field 204 described above) is displayed at business address 408. Contact information of the business (e.g., from further information field 210a described above) is displayed at business contact information 410. Various graphical indications of information regarding the business may be displayed at first-fifth icons 412a-412b. For example, one of icons 412a-412b may be an image that identifies a product of the business (e.g., an image file from farther information field 210b shown above).

Business and individual contact entries 300 and 400 are both shown arranged having an image on a left side, a column of textual information on a right side, and a row of icons along a bottom edge. However, in alternative embodiments, contact entries 300 and 400 may be arranged in any other manner. Furthermore, in alternative embodiments, contact entries 300 and 400 may include the information shown, may include additional information, and/or may include alternative information.

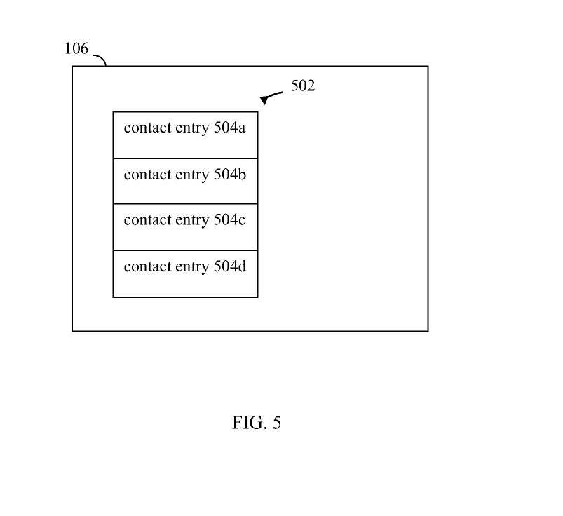

Address book tool 108 may cause one or more contact entries to be displayed by display 106 in any arrangement. For example, address book tool 108 may cause display of a single contact entry (e.g., one of contact entries 300 and 400) at a time. Alternatively, address book tool 108 may cause display of a list that includes multiple contact entries. For example, FIG. 5 shows display 106 displaying a list 502 of contact entries 504a-504d. List 502 may have any number of contact entries 504, including multiple contact entries 300, multiple contact entries 400, or any combination of one or more of contact entries 300 and 400. FIG. 5 shows list 502 arranged in single column form. However, in alternative embodiments, list 502 may be arranged in single row form, or may include an array of rows and columns of contact entries.

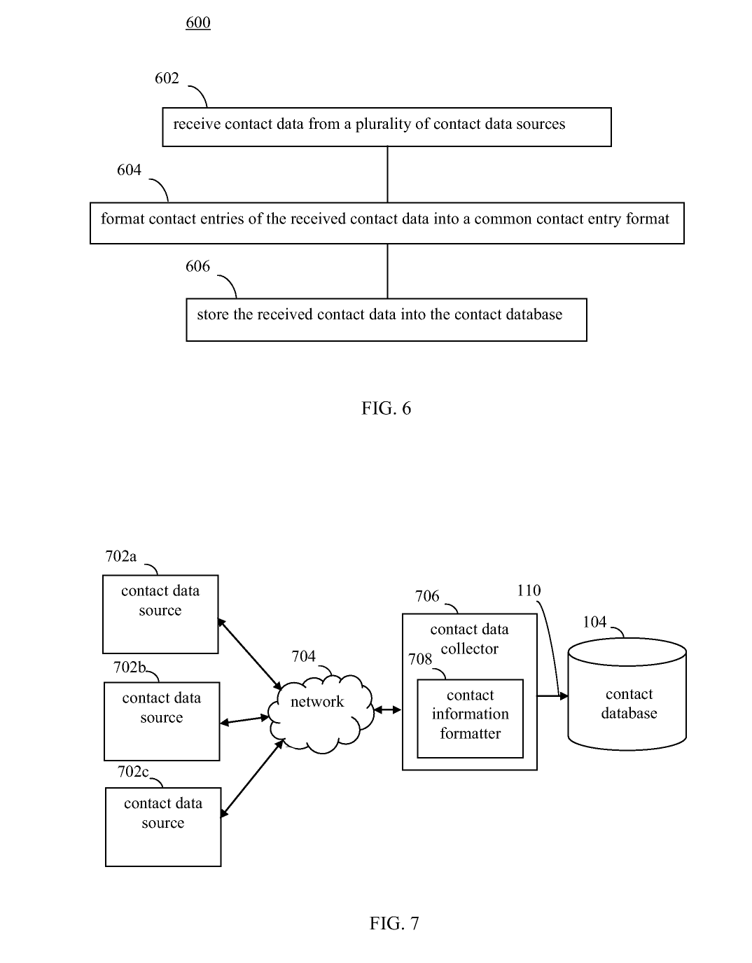

A user of computing device 102 may store contact entries 110 in contact database 104 in any manner. For example, one or more contact entries 110 may be manually stored in contact database 104 by the user on a one-by-one basis. In another example, contact entries 102 may be collected from a plurality of contact databases for various address book tools used by the user. For example, FIG. 6 shows a flowchart 600 providing example steps for collecting contact entries from multiple contact databases. FIG. 6 is described with respect to FIG. 7 for illustrative purposes. FIG. 7 shows a contact collection system 700, according to an example embodiment of the present invention. Other structural and operational embodiments will be apparent to persons skilled in the relevant art(s) based on the discussion regarding flowchart 600. Flowchart 600 is described as follows.

Flowchart 600 begins with step 602. In step 602, contact data is received from a plurality of contact data sources. For example, as shown in FIG. 7, contact collection system 700 includes a contact data collector 706. Contact data collector 706 is configured to import contact entries from a plurality of contact entry sources, such as contact data sources 702a-702c. Contact data sources 702a-702c may be any type of source of contact entries such as address book tools. Examples of contact data sources 702a-702c include a mobile phone contact list, a Microsoft™ Outlook contact list, online address books such as Yahoo!™ Address Book, Yahoo!™ Messenger, Gmail™, Flickr™, MSN™ Messenger, MySpace™, etc. Contact data collector 706 may communicate with contact data sources 702 to collect contact data in any manner. For example, contact data collector 706 may receive contact data from contact data sources 702 over a network 704. For instance, network 704 may be a local area network (LAN) (wired or wireless), a wide area network (WAN), or a combination of networks such as the Internet. Contact data collector 706 may be implemented in hardware, software, firmware, or any combination thereof, to perform its functions.

In step 604, contact entries of the received contact data are formatted into a common contact entry format. Step 604 is optional. As shown in FIG. 7, contact data collector 706 may include a contact information formatter 708. Contact information formatter 708, when present, may be used to format contact entries received from contact data sources 702 that are in different formats into a common contact entry format. Typically, such formatting entails extracting the various field code data of different received contact entry formats, and changing data entries for similar fields from the different formats into a uniform field code format (e.g., changing “business name” field data of the different formats into a common business name field data format). For example, formatter 708 may format contact entries into vCard or other standard or proprietary contact entry format. Formatter 708 may additionally be configured to format contact data from multiple sources 702 for a single contact into a single contact entry. Formatter 708 may be implemented in hardware, software, firmware, or any combination thereof, to perform its functions.

In step 606, the received contact data is stored into the contact database. As shown in FIG. 7, contact data collector 706 stores contact entries 110 received from contact data sources 702 (and optionally formatted) into contact database 104.

In an embodiment, contact data stored in contact database 104 may be ranked.

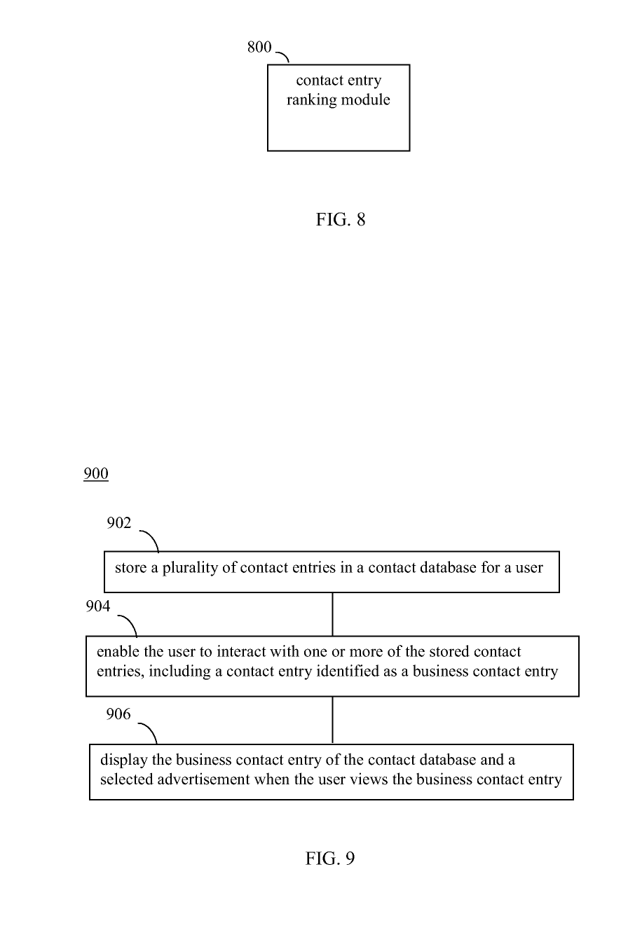

For example, FIG. 8 shows a contact entry ranking module 800, according to an embodiment of the present invention. Contact entry ranking module 800 may be located in address book tool 108, or may be located remote to computing device 102 (e.g., located in a server having access to contact database 104). Contact entry ranking module 800 may be configured to rank stored contact entries 110 based on one or more criteria, typically in relation to their importance to the user. By ranking contact entries 110 based on an importance to the user, information relating to more important contacts may be given more weight when selecting advertisements directed to the user than for information relating to less important contacts. Contact entry ranking module 800 may implemented in hardware, software, firmware, or any combination thereof.

For example, module 800 may rank a contact entry based on a contact data source from which the contact entry is received. For instance, a user may place more importance on some contact sources relative to others. In one example, contacts received from a cell phone of the user may be considered highly important, while less important contacts are received from a MySpace™ account/profile of the user. Thus, module 800 may give cell phone contacts a higher relevance/importance ranking than MySpace™ contacts. In another embodiment, module 800 may rank a contact entry based on a number of contact data sources (e.g., contact data sources 702) from which the contact entry is received. For instance, module 800 may be configured to provide a higher ranking to a contact present in many of the user's address books, such as their cell phone, MySpace™, Outlook™, and Snapfish™ address books, relative to a contact entry only present in a single address book of the user. In another embodiment, module 800 may be configured to provide a higher ranking to contacts that are accessed by the user most frequently. Contacts that are contacted more frequently tend to be more important, and thus their contact entries may include more relevant information than less frequently contacted contacts. Contact entries may be additionally or alternatively ranked based on further criteria, including frequency of use of contacts, time of use of contacts, etc.

As described above, embodiments of the present invention enable advertisements to be displayed using an address book tool. When a user views contact entries of the address book tool, one or more advertisements are displayed to the user. Embodiments provide a new advertising mechanism to advertisers. According to embodiments, advertising can be performed that is highly targeted, and thus is more efficient at reaching intended consumers. Such improvements in targeting of advertising can be leveraged to generate increased advertising revenue. In embodiments, users are enabled to quickly respond to advertising, such as by clicking on the advertisement to initiate a phone call, an email, or to open a website. Furthermore, in embodiments, available location data for the user may be used to provide convenient advertiser locations for the user.

In embodiments, the advertising businesses are located in the user's address book (e.g., may or may not have a pre-existing relationship with the user), and thus tend to be known to the user. In other embodiments, the advertising businesses may not be located in the user's address book, but are those that compete directly with the business contacts contained within the address book of the user. In either case, the advertising business will tend to be of interest to the user. Thus, the user will not feel as inconvenienced as in traditional online advertising where untargeted advertising is performed. However, in further embodiments, advertisements may be provided by advertisers that are not present in the in the user's address book and are not competitors of business contact entries of the user.

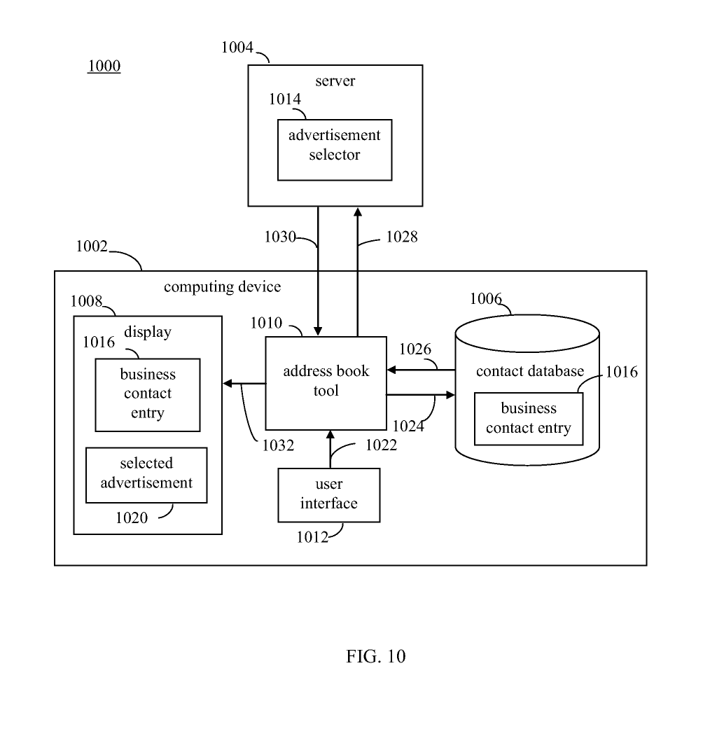

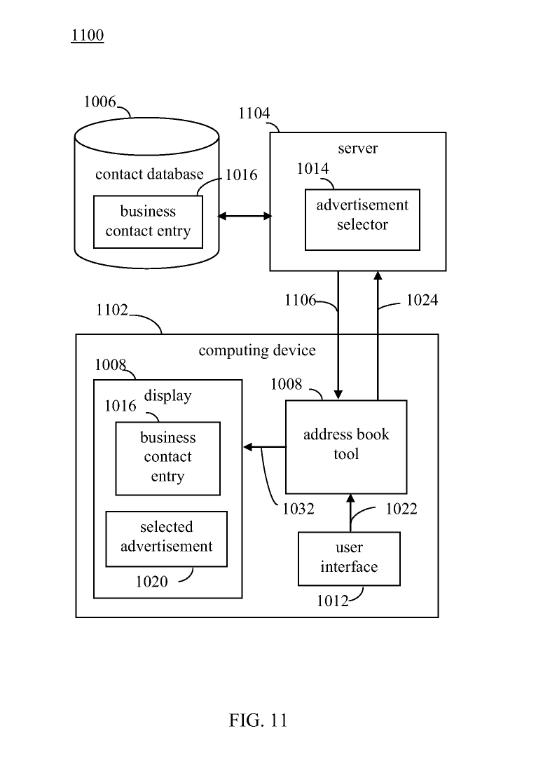

FIG. 9 shows a flowchart 900 providing example steps for displaying advertisements in an address book tool, according to an example embodiment of the present invention. FIG. 9 is described with respect to FIGS. 10 and 11 for illustrative purposes. FIG. 10 shows an address book system 1000, according to an example embodiment of the present invention. As shown in FIG. 10, address book system 1000 includes a computing device 1002, a server 1004, and a contact database 1006. FIG. 11 shows an address book system 1100, according to another embodiment of the present invention. As shown in FIG. 11, address book system 1100 includes computing device 1102 and a server 1104. Elements of address book systems 1000 and 1100 having the same name as elements of address book system 100 of FIG. 1 are generally the same as those elements of system 100 according to the description provided above, with differences described below. Other structural and operational embodiments will be apparent to persons skilled in the relevant art(s) based on the discussion regarding flowchart 900. Flowchart 900 is described as follows.

Flowchart 900 begins with step 902. In step 902, a plurality of contact entries are stored in a contact database for a user. In a similar fashion to contact database 104 of FIG. 1, contact database 1006 of FIGS. 10 and 11 may store a plurality of contact entries 110. For example, as shown in FIGS. 10 and 11, contact database 1006 stores a business contact entry 1016. Business contact entry 1016 is a contact entry for a business of interest to the user of system 1000. Business contact entry 1016 may be configured with content to be displayed in any manner, such as described above for business contact entry 400 shown in FIG. 4. Contact entries may be stored in contact database 1006 in any manner, such as on a manual basis by the user of system 1000, or in the manner described above with respect to FIGS. 6 and 7.

In the embodiment of FIG. 10, contact database 1006 is located local to computing device 1002. Contact database 1006 may be stored in a storage device internal to computing device 1002, or may be stored in a storage device external to computing device 1002 that is coupled to computing device 1002. In the embodiment of FIG. 11, contact database 1006 is located at server 1104. For example, in the embodiment of FIG. 11, contact database 1006 may be stored in a storage device internal to server 1104, or may be stored in a storage device external to server 1104 that is coupled to server 1104.

In step 904, the user is enabled to interact with one or more of the stored contact entries, including a contact entry identified as a business contact entry. In a similar fashion to address book tool 106 of computing device 102 shown in FIG. 1, address book tool 1010 of computing devices 1002 and 1102 (shown in FIGS. 10 and 11) enables a user to interact with contact entries stored in contact database 1006. Note that although address book tools 1010 and 1102 are shown located in computing devices 1002 and 1102, respectively, address book tools 1010 and 1102 may alternatively be located externally to computing devices 1002 and 1102. For example, a portion or all of address book tools 1010 and 1102 may be located in servers 1004 and 1104, respectively. For example, in such an embodiment, address book tools 1010 and 1102 may be browser-accessible (e.g., Internet-based).

As shown in FIGS. 10 and 11, computing devices 1002 and 1102 each include a user interface 1012 (which may also be present in computing device 102 of FIG. 1). User interface 1012 enables a user to interact with address book tool 1010 to add contact entries to contact database 1006, to edit contact entries in contact database 1006, to select contact entries for viewing by display 1008, etc. User interface 1012 may include one or more buttons, a keyboard, a voice activated input system, a touch screen (with display 1008), a wheel such as a click wheel, and/or other interface mechanism to enable the user to interact with address book tool 1010.

A user of computing devices 1002 and 1102 may desire to view a business contact entry of contact database 1006, such as business contact entry 1016. The user may desire to view the business contact entry in order to interact with the corresponding business, to provide information regarding the business to someone else, to modify information stored in the business contact entry, and/or for any other reason.

In an embodiment, a user interacts with address tool book 1010 at user interface 1012 to cause business contact entry 1016 to be displayed at display 1008. The user inputs a request 1022 at user interface 1012. Input request 1022 may be a request to view business contact entry 1016 specifically, a request to view a range (e.g., an alphabetical range) of contact entries of contact database 1006 (including business contact entry 1016), or any other request that causes business contact entry 1016 to be viewed. Address book tool 1010 receives input request 1022. Address book tool 1010 generates a contact entry request 1024 to contact database 1006 that includes a request for business contact entry 1016 (and potentially further contact entries).

In the embodiment of FIG. 10, contact database 1006 receives contact entry request 1024, and transmits a response 1026, which includes business contact entry 1016, and may include further contact entries. Address book tool 1010 receives response 1026. Business contact entry 1016 may be provided in the form of a file, such as contact entry file 200 shown in FIG. 2. In FIG. 10, address book tool 1010 identifies business contact entry 1016 as a business contact. For example, business contact entry 1016 may include a code/field that flags business contact entry 1016 as a contact for a business. Alternatively, address book tool 1010 may parse fields of business contact entry 1016 for data commonly present in business contact entries to make the identification (e.g., text such as “Inc.,” “.com,” etc.). Because business contact entry 1016 is identified as a contact entry for a business, address book tool 1010 transmits an advertisement request 1028 to server 1004, to request an advertisement (if available) to display with business contact entry 1016.

Server 1004 receives advertisement request 1028. As shown in FIG. 10, server 1004 includes an advertisement selector 1014, which selects an advertisement (or more than one advertisement) corresponding to business contact entry 1016. Server 1004 transmits a response 1030 that includes the selected advertisement(s).

Alternatively, in the embodiment of FIG. 11, server 1104 receives contact entry request 1024. For example, computing device 1102 and server 1104 may communicate with each other over a network, such as a LAN, WAN, or combination of networks such as the Internet. Server 1104 accesses contact database 1006 for business contact entry 1016. Furthermore, if server 1104 identifies business contact entry 1016 as a contact for a business (e.g., in an analogous manner as described above for address book tool 1010 in FIG. 10), advertisement selector 1014 of server 1104 selects an advertisement (or more than one advertisement) corresponding to business contact entry 1016. Server 1104 transmits a response 1106 that includes business contact entry 1016 (and potentially further contact entries) and the selected advertisement(s).

In the embodiment of FIG. 10, address book tool 1010 receives response 1026, which includes business contact entry 1016 from contact database 1006, and receives response 1030, which includes the selected advertisement from server 1004. In the embodiment of FIG. 11, address book tool 1010 receives response 1106, which includes business contact entry 1016 and the selected advertisement from server 1104. In each case, address book tool 1010 processes business contact entry 1016 and the selected advertisement (e.g., to format them for display). Address book tool 1010 transmits a display signal 1032, which includes business contact entry 1016 and the received selected advertisement, to display 1008.

In step 906, the business contact entry of the contact database and a selected advertisement are displayed when the user views the business contact entry. As shown in FIGS. 10 and 11, display 1008 receives display signal 1032 from address book tool 1010, and displays business contact entry 1016 and the selected advertisement (shown as selected advertisement 1020 in FIGS. 10 and 11) received therein.

In embodiments, a user may interact with a displayed advertisement. For example, a user may be enabled to interact with a selected advertisement to initiate a telephone call, to generate an email, and/or to access a website. For instance, the user may click on the displayed advertisement using a touch screen, mouse pointer, etc., to initiate a telephone call to the business, to generate an email to the business, or to display a website of the business corresponding to the selected advertisement.

Advertisements may be selected by advertisement selector 1014 in any manner.

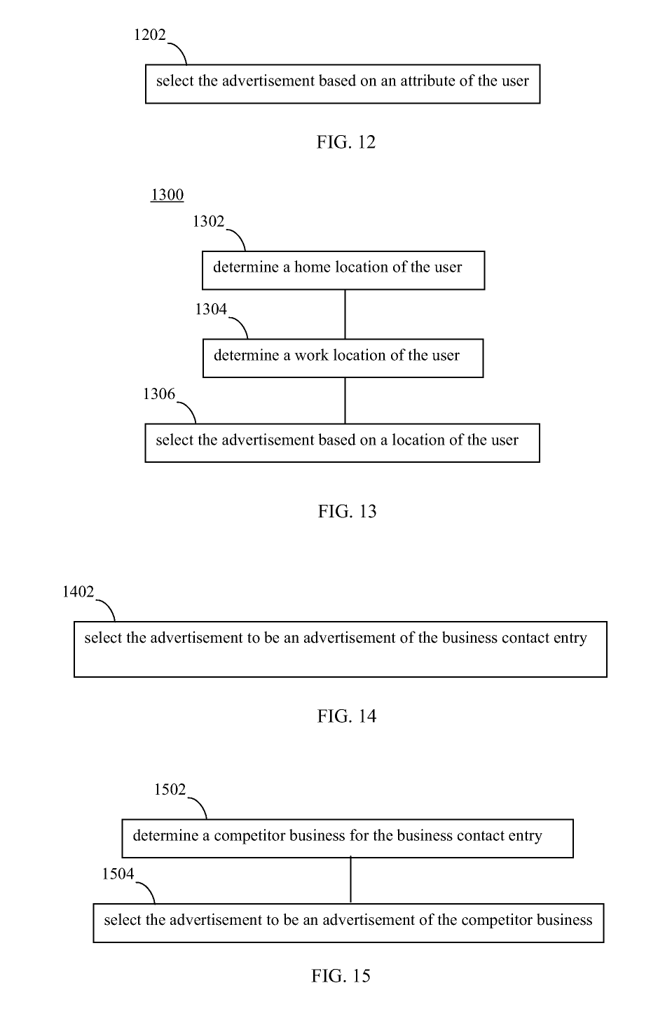

For example, in an embodiment, flowchart 900 of FIG. 9 may include step 1202 shown in FIG. 12. In step 1202, the advertisement is selected based on an attribute of the user. An advertisement may be selected for display with business contact entry 1016 based on an attribute of the user of computing device 1002 or 1102. For example, the attribute may be a preference of the user for a particular good (e.g., food, clothing, etc.) or service, a hobby or other interest of the user, a demographic attribute of the user, a location of the user, etc. Attributes/preferences of the user may be determined in a variety of ways. For example, such information may be included in a “Me” vCard of the user present in contact database 1006, or in other email and/or contact account of the user that is accessible by advertisement selector 1014. Furthermore, attributes/preferences of the user may be determined from the contact information of the contact entries in contact database 1006. Contact entry ranking module 800 may be used to rank contact entries to determine the contact entries most important to the user and therefore most likely to contain relevant attribute/preference information relating to the user.

For example, in an embodiment, step 1202 may include one or more of the steps of flowchart 1300 shown in FIG. 13 which relate to a location attribute of the user. In step 1302 of flowchart 1300, a home location of the user may be determined. For example, personal address and/or phone area code data from a “Me” vCard of the user present in contact database 1006, or in other email and/or contact account of the user that is accessible by advertisement selector 1014, may be analyzed to determine a home location of the user.

In step 1304 of flowchart 1300, a work location of the user may be determined. For example, work-related address and/or phone area code data from a “Me” vCard of the user present in contact database 1006, or in other email and/or contact account of the user that is accessible by advertisement selector 1014, may be analyzed to determine a work location of the user.

In step 1306 of flowchart 1300, the advertisement is selected based on a location of the user. For example, the advertisement may be selected based on the home location and/or work location of the user determined in steps 1302 and 1304, respectively. By taking into account the determined user location information when selecting an advertisement, an advertisement can be selected that is more likely to be relevant to the user. For example, an advertisement may be selected for a business that is relatively close to the home location and/or the work location of the user, such that the user can relatively easily access the business. In the case where a business has multiple locations (e.g., a major food chain), a closest location of the business to the user's home and/or work locations can be selected for listing in the advertisement.

FIG. 14 shows a step 1402 for selecting an advertisement, according to another embodiment of the present invention. In step 1402, the advertisement is selected to be an advertisement of the business contact entry. In this embodiment, the advertisement is selected to be an advertisement of the business corresponding to business contact entry 1016. Because business contact entry 1016 is present in contact database 1006 of the user, the business of business contact entry 1016 is likely to be of interest to the user. Thus, by selecting the advertisement to be an advertisement of business contact entry 1016, the advertisement is likely to be of interest to the user, and is therefore targeted to the user.

For instance, a user may desire a pizza from Joe's Pizza. The user may pick up computing device 1002, which may be a cell phone, for example. The user accesses address book tool 1010 on the cell phone, and starts typing J-O-E. The Joe's Pizza business contact card that the user previously entered into address book tool 1010 becomes selected, allowing the user to call Joe's Pizza to place an order. According to step 1402, an advertisement for Joe's Pizza is selected to be placed in the displayed Joe's Pizza business contact card (e.g., offering the user a free bottle of soda with orders over $15).

FIG. 15 shows a flowchart 1500 for selecting an advertisement, according to another embodiment of the present invention. In step 1502 of flowchart 1500, a competitor business for the business contact entry is determined. In step 1504, the advertisement is selected to be an advertisement of the competitor business. Because business contact entry 1016 is present in contact database 1006 of the user, a product or service of business contact entry 1016 is likely to be of interest to the user. The user may also be interested in learning about the same or similar products or services of other companies, which may have comparable or better features, and/or may cost less. Therefore, by selecting the advertisement to be an advertisement of a competitor of business contact entry 1016, the advertisement is likely to be of interest to the user.

As in the above example, a user may desire a pizza from Joe's Pizza. However, Luigi's Pizza (a competitor) may have just opened a new store near the home location of the user (e.g., determined by analyzing the home address from the user's contact card and the local area code for Joe's Pizza in the business contact card). When the user accesses the Joe's Pizza business contact card, according to flowchart 1500, an offer from Luigi's Pizza is displayed to let the user view an advertisement for the new store (e.g., pizzas at the new Luigi's Pizza location are half priced). Thus, in this example, the user is offered a potentially better offer (at least pricewise in the current example) for a product, and may consider purchasing a pizza from Luigi's Pizza rather than Joe's Pizza.

In another example, a user's online searching keywords are analyzed to determine that the user is interested in buying a Nintendo Wii™. The user locates Toys R Us™ in the user's address book. According to flowchart 1500, an advertisement is also displayed in the address tool book offering an online method of purchasing the Nintendo Wii™ from a competitor of Toys R Us™ (e.g., a 1-click purchase option for the Nintendo Wii™, having it delivered to the user's home with next day delivery for below the RRP (recommended retail price)). Because of the ease of delivery and reduced cost in this example, the user may consider making the purchase according to the advertisement rather than from Toys R Us™.

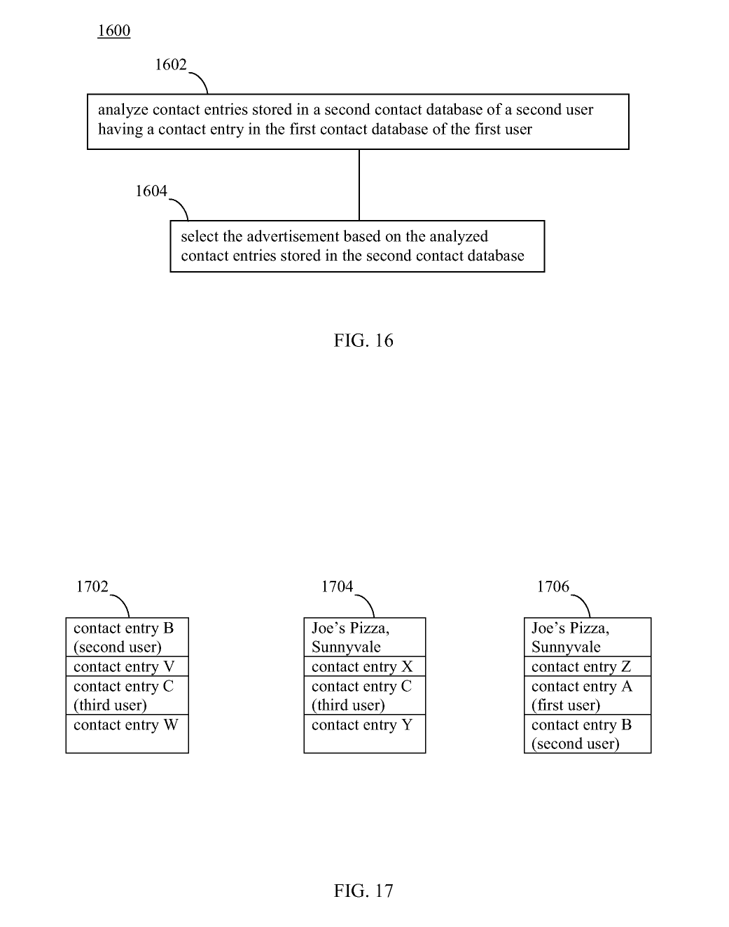

In another example, advertisement selector 1014 may be configured to select the advertisement based on one or more contact entries stored in one or more other contact databases. For instance, in an embodiment, flowchart 900 of FIG. 9 may include the steps of flowchart 1600 shown in FIG. 16, described below. For illustrative purposes, flowchart 1600 is described with respect to FIG. 17, which shows first, second, and third contact databases 1702, 1704, and 1706, according to an example embodiment of the present invention. First contact database 1702 is a contact database (e.g., contact database 1006 shown in FIGS. 10 and 11) of a first user, second contact database 1704 is a contact database of a second user, and third contact database 1706 is a contact database of a third user. Contact database 1702 stores contact entries of interest to the first user, including contact entries of the second and third users, among other contact entries. Contact database 1704 stores contact entries of interest to the second user, such as contact entries for Joe's Pizza, Sunnyvale, and the third user. Contact database 1706 stores contact entries of interest to the third user, including contact entries for Joe's Pizza, Sunnyvale, the first user, and the second user. In an embodiment, advertising may be selected for display to the first user based at least in part on an analysis of contact entries stored in the second and/or third contact databases 1704 and 1706 of the second and third users. In an example embodiment, first-third contact databases 1702-1706 are stored in a common storage medium, but in other embodiments, may be distributed across multiple storage mediums.

In step 1602 of flowchart 1600, contact entries stored in a second contact database of a second user having a contact entry in the first contact database of the first user are analyzed. For example, referring to FIG. 17, contact entries in second and/or third contact databases 1704 and 1706 (and potentially further contact databases) can be analyzed. Advertisement selector 1014 may determine a relationship between the first user with the second and third user through an analysis of first-third contact databases 1702, 1704, and 1706. As shown in FIG. 17, contact database 1702 of the first user stores contact entries for the second and third users, and therefore a relationship may be assumed to be present between the first user and the second and third users. Because the first user has contact entries for the second and third users, it is possible, and even likely, that the first user may have overlapping interests with the second and third users, and thus may be interested in advertisements that are selected based on information stored in second and third contact databases 1704 and 1706. Thus, second and/or third contact databases 1704 and 1706 can be analyzed for such information. For instance, second and third users both have a contact entry for Joe's Pizza, Sunnyvale, in their respective contact databases 1704, 1706. Although the Joe's Pizza, Sunnyvale, contact entry is not present in contact database 1702 of the first user, the first user may be interested in Joe's Pizza, Sunnyvale. Thus, advertisements related to Joe's Pizza, Sunnyvale, may be selected for display to the first user.

Any attribute of the contact information stored in other user contact databases may be used to find advertisements of interest to the first user. Such attributes may include any information/attributes described elsewhere herein or otherwise known. Furthermore, any business contact entries in the other contact databases may be determined, advertisements previously viewed by the other users may be determined, and advertisements the other users have previously responded to may be determined, to determine advertisements based on contact entries of other users. The information determined from analysis of other contact databases may be ranked based upon various factors, including a frequency of appearance of the information (e.g., appearance of a particular business contact entry) in the other contact databases.

Furthermore, a closeness of the relationship between the first user and a second user may be analyzed to find advertisements of interest. For example, as shown in FIG. 17, contact database 1704 of the second user does not include a contact entry for the first user. In contrast, contact database 1706 of the third user does include a contact entry for the first user. Thus, the relationship between the first user and the second user is not reciprocal, while the relationship between the first user and the third user is reciprocal. Therefore, information determined from analysis of contact database 1706 of the third user may be more useful in determining advertisements of interest to the first user than information determined from analysis of contact database 1704 of the second user.

In step 1604, the advertisement is selected based on the analyzed contact entries stored in the second contact database. For instance, in the current example of FIG. 17, an advertisement may be selected for display to the first user based on the analysis of contact entries stored in contact database 1704 and/or in contact database 1706. As described above, because Joe's Pizza, Sunnyvale, appears in contact databases 1704 and 1706, an advertisement for Joe's Pizza, Sunnyvale (or for a competitor) may be selected. Additionally, one or more attributes of the first user may be taken into account when selecting the advertisement. For instance, if the first user is determined to currently be in a location other than Sunnyvale (e.g., in New York), the first user may be interested in Joe's Pizza in that other location (e.g., Joe's Pizza, New York). Thus, an advertisement for Joe's Pizza, New York (or other location) (or a competitor) may be selected.

Thus, in the manner of FIGS. 16 and 17, advertising based on the interests of individuals listed in a user's contact database address book may be selected. As described above, additional factors, such as a location of the user, whether the relationship is reciprocal, etc., may be used to generate an even more complete profile for the user, and therefore provide even more highly targeted advertising to the user.

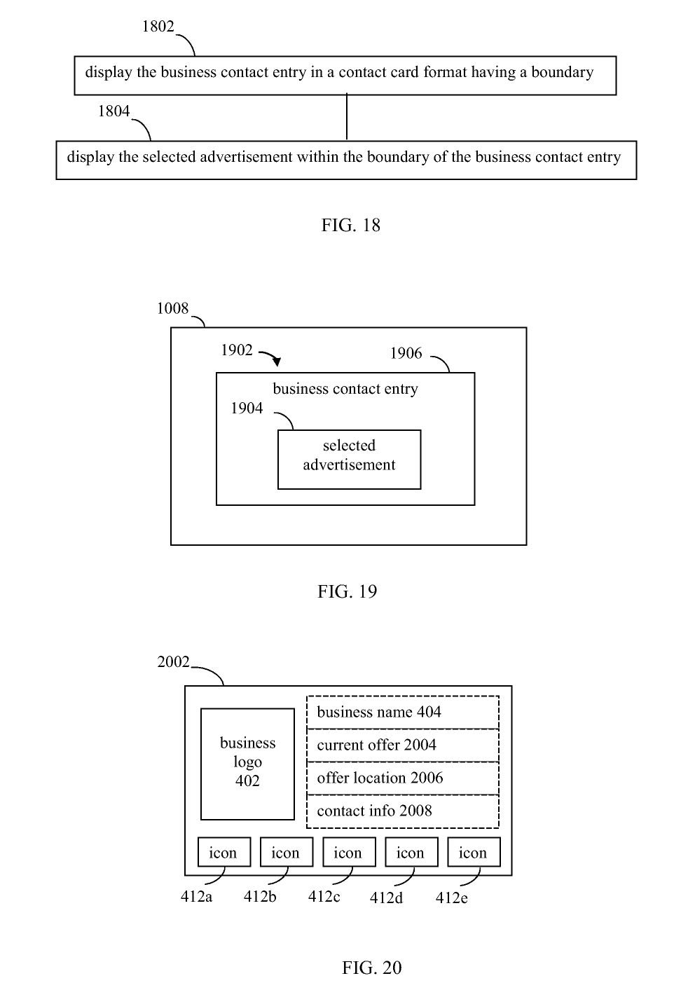

Business contact entry 1016 of FIG. 10 may be displayed by display 1008 in a variety of formats. For example, business contact entry 1016 may be displayed singly, or may be displayed with other contact entries. Business contact entry 1016 may be displayed in a textual format, or in a graphical format (e.g., including text and images), such as in a graphical vCard format. Furthermore, selected advertisement 1020 may be displayed with business contact entry 1016 in any manner. For example, selected advertisement 1020 may be displayed within a boundary of business contact entry 1016, or outside a boundary of business contact entry 1016. Example ways of displaying business contact entry 1016 and selected advertisement 1020 are described as follows with regards to FIGS. 18-23.

FIG. 18 shows a flowchart 1800 for displaying business contact entry 1016 and selected advertisement 1020, according to an example embodiment of the present invention. In step 1802 of flowchart 1800, the business contact entry is displayed in a contact card format having a boundary. For example, FIG. 19 shows a block diagram of display 1008 displaying a business contact entry 1902, which is an example of business contact entry 1016, and displaying a selected advertisement 1904, which is an example of selected advertisement 1020. As shown in FIG. 19, business contact entry 1902 has a boundary 1906, which is rectangular. In the example of FIG. 19, business contact entry 1902 is displayed as a graphical business card, and boundary 1906 is a perimeter edge of the rectangular card. However, in alternative embodiments, business contact entry 1902 may be displayed in a different shape than rectangular, including circular, etc.

In step 1804 of flowchart 1800, the selected advertisement is displayed within the boundary of the business contact entry. For example, as shown in FIG. 19, selected advertisement 1904 is displayed within boundary 1906 of business contact entry 1902. In embodiments, selected advertisement 1904 can be displayed in a region of business contact entry 1902 designated for display of advertisements, in an empty region of business contact entry 1902, or in a region of business contact entry 1902 where contact data is typically present.

For example, FIG. 20 shows a business contact entry 2002, which is an example of business contact entry 1902 of FIG. 19. In FIG. 20, selected advertisement 1902 is displayed within a boundary of business contact entry 2002 in a region where contact data is typically present. In the example of FIG. 20, selected advertisement 1902 is displayed as a current offer 2004, an offer location 2006, and contact information 2008. Current offer 2004, offer location 2006, and contact information 2008 replace standard fields (business status 406, business address 408, and business contact information 410) of business contact entry 400 shown in FIG. 4. Current offer 2004 includes textual (and/or graphical) information describing the current offer. Offer location 2006 includes textual (and/or graphical) information describing a location of the offer of current offer 2002. Contact information 2008 includes textual (and/or graphical) information describing a manner in which the location of offer location 2006 may be contacted.

For example, business contact entry 2002 may be a contact entry for a pizza business. In such an example, current offer 2004 may be a pizza special, such as “two pizzas for the price of one!” Offer location 2006 may be an address for a local franchise (e.g., closest to the user) of the pizza business, and contact information 2008 may be a phone number for the local franchise.

The pizza business and other examples described above are described for purposes of illustration. Business contact entries 1016, 1902, and 2002 may be configured for any type of business, including businesses providing any goods and/or services described elsewhere herein or otherwise known. Furthermore, any number of fields of a business contact entry, including graphical and textual fields, may be overwritten with data of a selected advertisement.

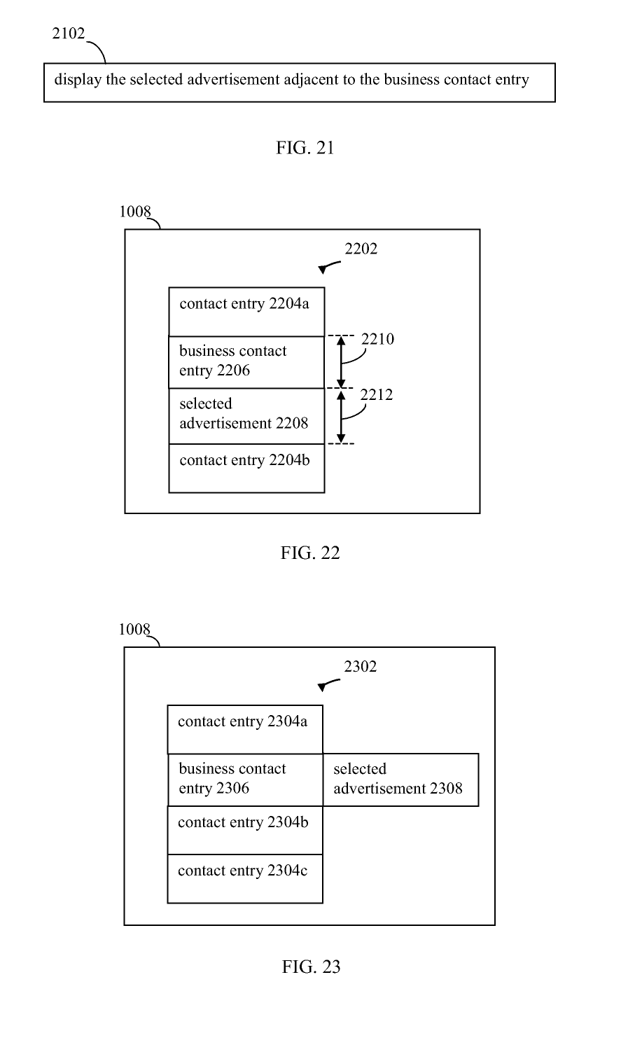

Furthermore, note that in alternative embodiments to FIG. 19, selected advertisement 1904 may be displayed as overlapping boundary 1906 of business contact entry 1902, or may be displayed outside of boundary 1906 of business contact entry 1902. For instance, FIG. 21 shows a step 2102 for displaying business contact entry 1016 and selected advertisement 1020 of FIG. 10, according to another example embodiment of the present invention. In step 2102, the selected advertisement is displayed adjacent to the business contact entry. FIGS. 22 and 23 show example embodiments for step 2102.

FIG. 22 shows a list 2202 of contact entries and one or more advertisements being displayed by display 1008. List 2202 may include business contact entries and individual contact entries. As shown in FIG. 22, list 2202 includes a contact entry 2204a, a business contact entry 2206, a selected advertisement 2208, and a contact entry 2204b. Business contact entry 2206 is an example of business contact entry 1016, and selected advertisement 2208 is an example of selected advertisement 1020. In the embodiment of FIG. 22, selected advertisement 2208 is displayed in list 2202 with business contact entry 2206, outside of a boundary of business contact entry 2206. Although shown in FIG. 22 as being positioned below business contact entry 2206 in list 2202, selected advertisement 2208 may be alternatively positioned above business contact entry 2206 in list 2202. As shown in FIG. 22, business contact entry 2206 has a height 2210, and selected advertisement 2208 has a height 2212. Heights 2210 and 2212 are shown as approximately equal in FIG. 22. Alternatively, height 2210 of business contact entry 2206 may be greater than or less than height 2212 of selected advertisement 2208.

FIG. 23 shows a list 2302 of contact entries and one or more advertisements being displayed by display 1008. List 2302 may include business contact entries and individual contact entries. As shown in FIG. 23, list 2302 includes a contact entry 2304a, a business contact entry 2306, a selected advertisement 2308, and a contact entry 2304b. Business contact entry 2306 is an example of business contact entry 1016, and selected advertisement 2308 is an example of selected advertisement 1020. In the embodiment of FIG. 23, selected advertisement 2308 is displayed outside of a boundary of business contact entry 2306, adjacent to list 2302. Although shown in FIG. 23 as being positioned to the right of list 2302, selected advertisement 2308 may be alternatively positioned to the left of list 2302, or may be positioned elsewhere in display 1008.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of advertising, comprising:
storing a plurality of contact entries in a contact database for a user;
enabling the user to interact with one or more of the stored contact entries, the one or more stored contact entries including a contact entry identified as a business contact entry; and
displaying the business contact entry of the contact database and a selected advertisement when the user views the business contact entry.

2. The method of claim 1, further comprising:
receiving contact data from a plurality of contact data sources, the contact data including at least one contact entry; and
storing the received contact data into the contact database.

3. The method of claim 1, further comprising:
selecting the advertisement based on a location of the user.

4. The method of claim 1, further comprising:
selecting the advertisement to be an advertisement of the business contact entry.

5. The method of claim 1, further comprising:
determining a competitor business for the business contact entry; and
selecting the advertisement to be an advertisement of the competitor business.

6. The method of claim 2, further comprising:
ranking contact entries of the contact database based on at least one criteria.

7. The method of claim 1, wherein said displaying comprises:
displaying the business contact entry in a contact card format having a boundary; and
displaying the selected advertisement within the boundary of the business contact entry.

8. The method of claim 1, wherein said displaying comprises:
displaying the business contact entry in a contact card format; and
displaying the selected advertisement adjacent to the business contact entry.

9. The method of claim 8, wherein said displaying the selected advertisement adjacent to the business contact entry comprises:
displaying the business contact entry and the selected advertisement in a list of contact entries of the contact database.

10. The method of claim 1, further comprising:
enabling the user to interact with the selected advertisement.

11. The method of claim 1, further comprising:
analyzing contact entries stored in a second contact database of a second user having a contact entry in the first contact database of the first user;
selecting the advertisement based on the analyzed contact entries stored in the second contact database.

12. A system, comprising:
a contact database configured to store contact entries for a user;
an address book tool configured to enable the user to interact with the stored contact entries; and
an advertisement selector configured to select an advertisement corresponding to a business contact entry stored in the contact database;
wherein the address book tool is configured to generate a display signal to cause a display device to display the business contact entry with the selected advertisement upon interaction by the user with the business contact entry in the address book tool.

13. The system of claim 12, further comprising:
a contact data collector configured to collect contact data from a plurality of contact data sources, the contact data including at least one contact entry;
wherein the contact data collector is configured to store received contact data into the contact database.

14. The system of claim 12, wherein the advertisement selector is configured to select the advertisement based on a location of the user.

15. The system of claim 12, wherein the advertisement selector is configured to select the advertisement to be an advertisement of the business contact entry.

16. The system of claim 12, wherein the advertisement selector is configured to select the advertisement to be an advertisement of a competitor business for the business contact entry.

17. The system of claim 13, further comprising:
a contact entry ranking module configured to rank a contact entry of the contact database based on one or more of a contact data source from which the contact entry is received or a number of contact data sources from which the contact entry is received.

18. The system of claim 12, wherein the business contact entry is displayed by the display device in a contact card format having a boundary, and the selected advertisement is displayed by the display device within the boundary of the business contact entry.

19. The system of claim 12, wherein the business contact entry is displayed by the display device in a contact card format, and the selected advertisement is displayed by the display device adjacent to the business contact entry.

20. The system of claim 19, wherein the business contact entry and the selected advertisement are displayed by the display device in a list of contact entries of the contact database.

21. The system of claim 12, wherein the address book tool enables the user to interact with the selected advertisement.

22. The system of claim 12, wherein the advertisement selector is configured to select the advertisement based on contact entries stored in a second contact database of a second user having a contact entry in the first contact database of the first user.

23. A computer system, comprising:
an address book tool configured to enable the user to interact with contact entries stored in a contact database;
wherein the address book tool is configured to communicate with an advertisement selector configured to select an advertisement corresponding to a business contact entry stored in the contact database; and
wherein the address book tool is configured to generate a display signal to cause a display device to display the business contact entry with the selected advertisement upon interaction by the user with the business contact entry in the address book tool

24. A server, comprising:
an advertisement selector configured to receive an advertisement request from an address book tool;
wherein the advertisement selector is configured to select an advertisement corresponding to a business contact entry indicated by the advertisement request; and
wherein the advertisement selector is configured to transmit a response to the address book tool that includes the selected advertisement;
wherein the address book tool is configured to generate a display signal to cause a display device to display the business contact entry with the selected advertisement upon interaction by a user with the business contact entry in the address book tool.

25. A computer program product comprising a computer usable medium having computer readable program code means embodied in said medium for an address book tool, comprising:
a first computer readable program code means for enabling a processor to enable a user to view contact entries stored in a contact database, including a contact entry identified as a business contact entry; and
a second computer readable program code means for enabling a processor to display the business contact entry of the contact database and a selected advertisement upon interaction by the user with the business contact entry according to the first computer readable program code means.
